(19) United States
(12) Patent Application Publication
(10) Pub. No.: US 2026/0046902 A1
(43) Pub. Date: Feb. 12, 2026

(54) NETWORK DEVICE, USER EQUIPMENT AND METHOD FOR RESOURCE ALLOCATION WITHIN COT UNDER SIDELINK TRANSMISSION

(71) Applicant: LENOVO (BEIJING) LIMITED, Beijing (CN)

(72) Inventors: Zhennian SUN, Beijing (CN); Haipeng LEI, Beijing (CN); Xiaodong YU, Beijing (CN); Xin GUO, Beijing (CN)

(21) Appl. No.: 19/102,559

(22) PCT Filed: Aug. 11, 2022
(86) PCT No.: PCT/CN2022/111731

§ 371 Date: Feb. 10, 2025

(51) Int. Cl. H04W 72/25; H04W 74/0808

(52) U.S. Cl. CPC H04W 72/25; H04W 74/0808

(57) ABSTRACT

The present application relates to a network device, UEs and method for resource allocation within COT under sidelink transmission. The UEs transmit information to the network device. The network receives information from the UEs under a sidelink network. The network device allocates resources within a COT, which is initiated by a first UE of the UEs, to the UEs according to the information.

### TECHNICAL FIELD

Embodiments of the present application generally relate to wireless communication technology, especially to a network device, a user equipment and method for resource allocation within channel occupancy time (COT) under sidelink transmission of 3GPP (3rd Generation Partnership Project) 5G new radio (NR).

### BACKGROUND

With network developments of 3rd Generation Partnership Project (3GPP) 5G New Radio (NR), sidelink transmission between user equipment (UE) is developed. In some cases, a network device allocates sidelink transmission resources for the UEs, and the UEs needs to perform listen-before-talk (LBT) before utilizing the allocated resources. When a first UE successfully accesses the channel and performs first transmissions on the allocated resources, the first transmissions may impact LBT performed by a second UE and cause LBT failure. A gap reserved by the network device may be introduced for the second UE to perform LBT without being impacted by the first transmissions. However, the gap being from several symbols to several slots may seriously decrease the spectrum efficiency.

### SUMMARY

Some embodiments of the present application provide a network device. The network device includes a processor and a transceiver coupled to the processor. The processor is configured to: receive, via the transceiver, information from a plurality of user equipment (UEs) under a sidelink network; and allocate resources within a channel occupancy time (COT) to the UEs according to the information, wherein the COT is initiated by a first UE of the UEs.

Some embodiments of the present application provide a first UE. The first UE includes a processor and a transceiver coupled to the processor. The processor is configured to: transmit, via the transceiver, information to a network device under a sidelink network for the network device to allocate resources within a COT to a plurality of UEs according to the information, wherein the plurality of UEs include the first UE and the COT is initiated by the first UEs; and receive, via the transceiver, at least one resource allocation from the network device.

Some embodiments of the present application provide a method of a network device. The method includes: receiving, via the network device, information from a plurality of UEs under a sidelink network; and allocating, via the network device, resources within a COT to the UEs according to the information, wherein the COT is initiated by a first UE of the UEs.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates a schematic diagram of message transmission in accordance with some embodiments of the prior art.

FIG. 3A illustrates a schematic diagram of message transmission in accordance with some embodiments of the present application.

FIGS. 3B and 3C are schematic diagrams of resources allocations in accordance with some embodiments of the present application.

FIG. 4A illustrates a schematic diagram of message transmission in accordance with some embodiments of the present application.

FIGS. 4B and 4C are schematic diagrams of resources allocations in accordance with some embodiments of the present application.

FIG. 5 illustrates a flow chart of a method for wireless communications in accordance with some embodiments of the present application.

FIG. 6 illustrates a flow chart of a method for wireless communications in accordance with some embodiments of the present application.

FIG. 7 illustrates a flow chart of a method for wireless communications in accordance with some embodiments of the present application.

FIG. 8 illustrates a block diagram of a user equipment in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR (new radio), etc. It is contemplated that along with the 3GPP and related communication technology development, the terminologies recited in the present application may change, which should not affect the principle of the present application.

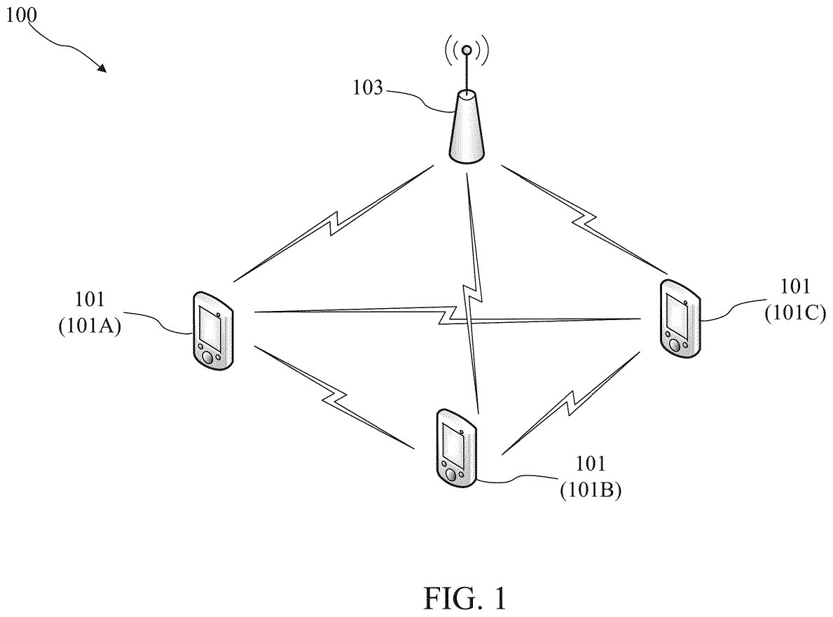

FIG. 1 illustrates a schematic diagram of a wireless communication system 100 in accordance with some embodiments of the present application. The wireless communication system 100 includes user equipment (UEs) 101 and a base station (BS) 103. Although a specific number of UEs 101 and BS 103 are depicted in FIG. 1, it is contemplated that any number of UE, BS and core network (CN) may be included in the wireless communication system 100.

The BS 103 may be distributed over a geographic region. In certain embodiments of the present application, the BS 103 may also be referred to as an access point, an access terminal, a base, a base unit, a macro cell, a Node-B, an evolved Node B (eNB), a gNB, a Home Node-B, a relay node, or a device, or described using other terminology used in the art. The BS 103 is generally part of a radio access network that may include one or more controllers communicably coupled to one or more corresponding BS(s).

The UEs 101 may include, for example, but is not limited to, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), Internet of Thing (IoT) devices, or the like.

According to some embodiments of the present application, the UEs 101 may include, for example, but is not limited to, a portable wireless communication device, a smart phone, a cellular telephone, a flip phone, a device having a subscriber identity module, a personal computer, a selective call receiver, a wireless sensor, a monitoring device, or any other device that is capable of sending and receiving communication signals on a wireless network.

In some embodiments of the present application, the UEs 101 may include, for example, but is not limited to, wearable devices, such as smart watches, fitness bands, optical head-mounted displays, or the like. Moreover, the UEs 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UEs 101 may communicate with each other via sidelink transmission. The sidelink transmission may include a control information transmission on physical sidelink control channel (PSCCH), a data transmission on physical sidelink shared channel (PSSCH) or feedback transmission on physical sidelink feedback channel (PSFCH). The UEs 101 may respectively communicate with the BS 103 via uplink communication signals.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present application, the UEs 101 and BS 103 may communicate using other communication protocols, such as the IEEE 802.11 family of wireless communication protocols. Further, in some embodiments of the present application, the UEs 101 and BS 103 may communicate over licensed spectrums, whereas in other embodiments, the UEs 101 and the BS 103 may communicate over unlicensed spectrums. The present application is not intended to be limited to the implementation of any particular wireless communication system architecture or protocol. In yet some embodiments of present application, the BS 103 may communicate with the UEs 101 using the 3GPP 5G protocols.

According to existing agreements, a sidelink transmission mode 1 is introduced for the BS 103 to allocate resources of sidelink transmission for UEs 101. The UEs 101 may perform sidelink transmission on unlicensed band, and the UEs 101 may perform listen-before-talk (LBT) procedure (type 1 LBT or type 2 LBT) before the sidelink transmission.

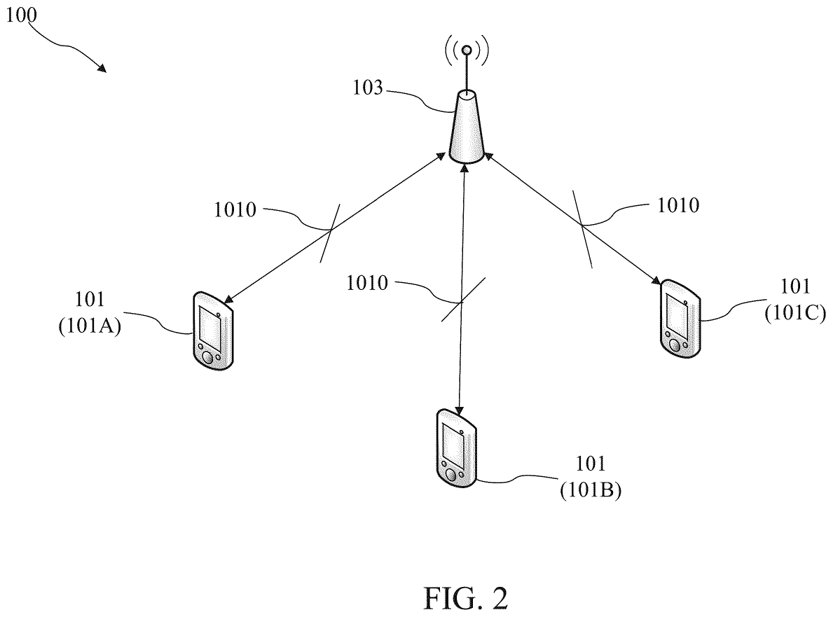

FIG. 2 is a schematic diagram of message transmission in accordance with some embodiments of the present application. In the present disclosure, the BS 103 may allocate different channel occupancy time (COT) structures for the UEs 101 to increase the resource utilization efficiency of sidelink transmission. In particular, the UEs 101 transmits information 1010 to the BS 103. After receiving the information 1010, the BS 103 allocate resources within a COT, which is initiated by one of the UEs 101, to the UEs 101 according to the information 1010. More details on embodiments of the present disclosure will be further described hereinafter.

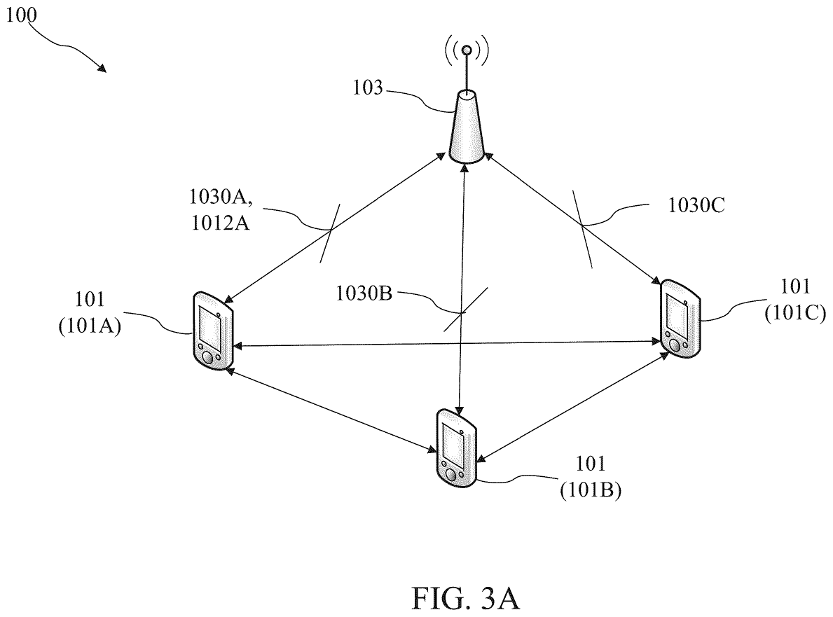

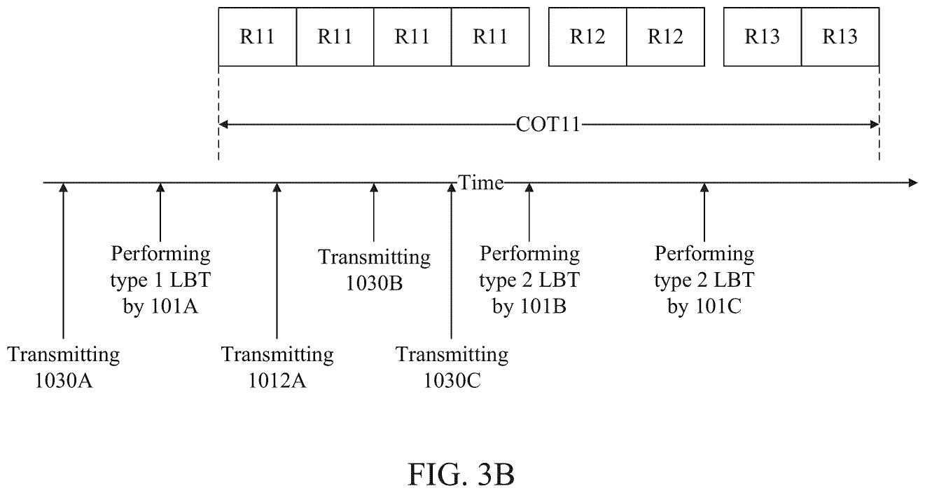

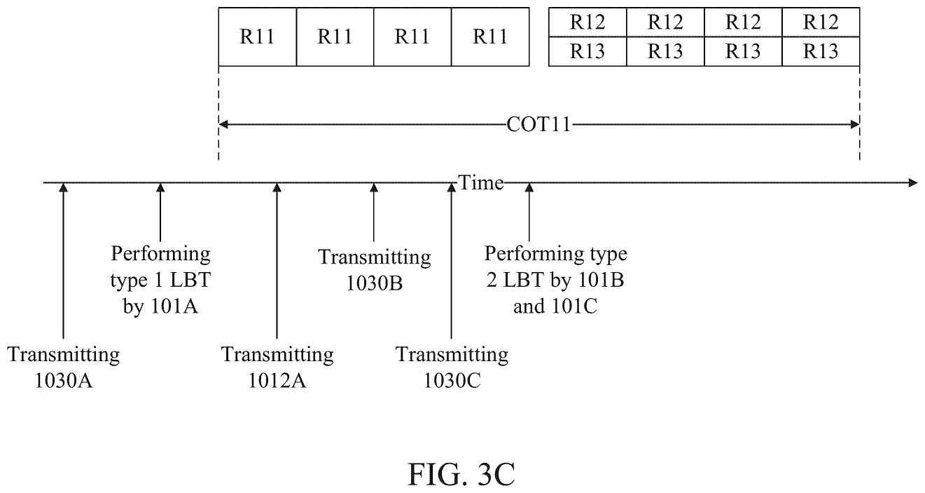

FIG. 3A is a schematic diagram of message transmission in accordance with some embodiments of the present application. FIGS. 3B and 3C are schematic diagrams of resources allocations in accordance with some embodiments of the present application. In some embodiments, after receiving the information 1010, the BS 103 allocates resources R11 to the UE 101A and transmits a resource allocation 1030A to inform the UE 101A of the allocated resources R11 for sidelink transmission. It should be noted that the BS 103 may allocate one additional resource on an interface, which is between the UE 101A and the BS 103, (e.g., PUCCH or PUSCH resource on Uu interface) to the UE 101A for the UE 101A to report LBT outcome.

Then, the BS 103 instructs the UE 101A to perform type 1 LBT. When the UE 101A successful accesses a channel with type 1 LBT and initiates a COT C11 on the channel, the UE 101A transmits an LBT report 1012A to the BS 103. After receiving the LBT report 1012A, the BS 103 allocates resources R12 within the COT C11 to the UE 101B and allocates resources R13 within the COT C11 to the UE 101C according to the information 1010 transmitted from the UE 101.

Next, the BS 103: (1) transmits a resource allocation 1030B to inform the UE 101B of the allocated resources R12, and instructs the UE 101B to perform a type 2 LBT within the COT C11 based on the allocated resources R12 according to resource allocation 1030B; and (2) transmits a resource allocation 1030C to inform the UE 101C of the allocated resources R13, and instructs the UE 101C to perform a type 2 LBT within the COT C11 based on the allocated resources R13 according to resource allocation 1030C.

In some implementations, as shown in FIG. 3B, the UEs 101B and 101C are allocated with different time slots based on the resource allocations 1030B and 1030C, i.e., the transmissions by the UEs 101B and 101C are time-division multiplexed. It should be noted that a first gap duration for the UE 101B to perform the type 2 LBT may be configured during last slot of allocated resources R11, and a second gap duration for the UE 101C to perform the type 2 LBT may be configured during last slot of allocated resources R12.

In some implementations, as shown in FIG. 3C, the UEs 101B and 101C are allocated with the same time slots and different frequencies based on the resource allocations 1030B and 1030C, i.e., the transmissions by the UEs 101B and 101C are frequency-division multiplexed. It should be noted that a gap duration for the UEs 101B and 101C to perform the type 2 LBT may be configured during last slot of allocated resources R11.

In some cases, the mentioned gap durations may be included in downlink control information (DCIs) (not shown) respectively transmitted to the UE 101B and the UE 101C. For example, a 2-bit field of DCI is used for indicating gap duration. ‘00’ is used for indicating “no gap duration”, ‘01’ is used for indicating 25 μs and ‘10’ is used for indicating 16μs.

In some cases, the mentioned gap durations and may be a fixed value or configured by higher layer signaling transmitted from the BS 103.

In some cases, the mentioned gap duration may be indicated by a presence of the resource for the UE 101A to report LBT outcome. For example, when the BS 103 allocates the resource for the UE 101A to report LBT outcome, it means that the UE 101A is configured with the gap duration G12 in end of the last slot. When the BS 103 does not allocate any resource for the UE 101A to report LBT outcome, it means that the UE 101A is not configured with any gap duration.

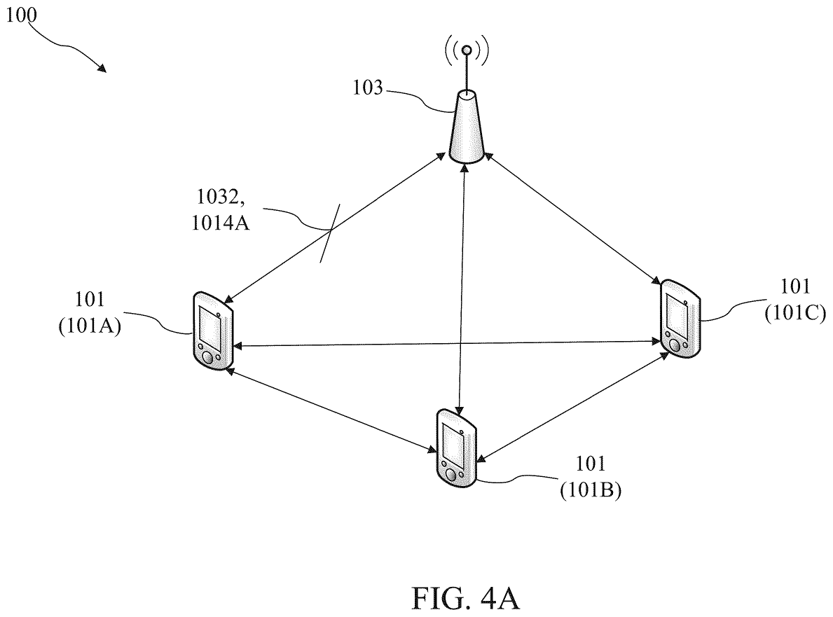

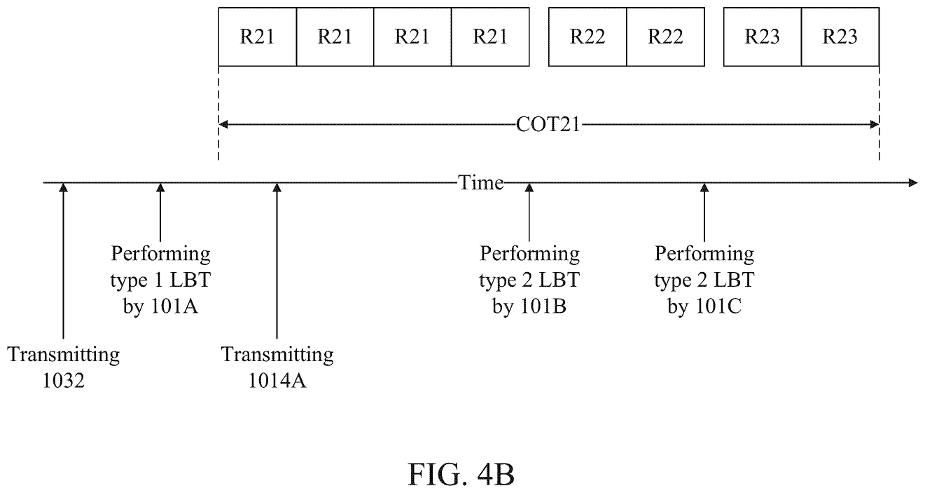

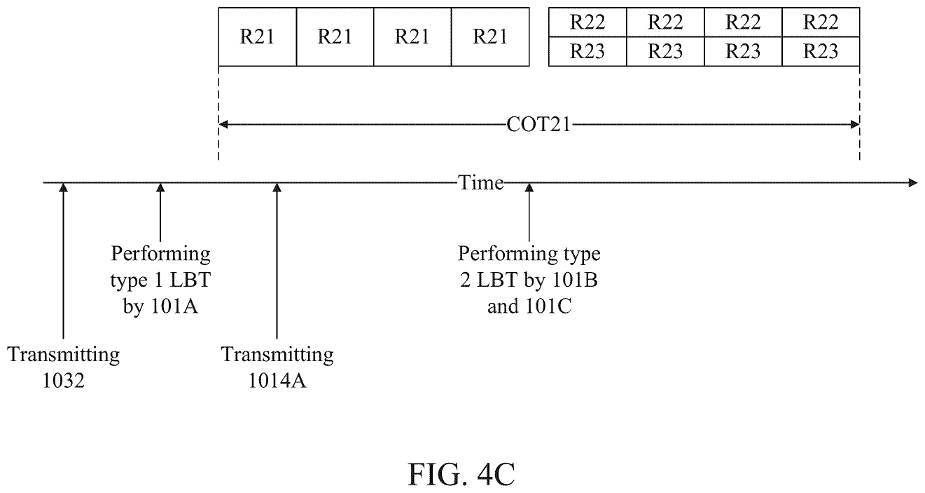

FIG. 4A is a schematic diagram of message transmission in accordance with some embodiments of the present application. FIGS. 4B and 4C are schematic diagrams of resources allocations in accordance with some embodiments of the present application. In some embodiments, after receiving the information 1010, the BS 103 respectively allocates resources R21, R22 and R23 to the UE 101A, 101B and 101C. Then, the BS 103 transmits a resource allocation 1032 to inform the UE 101A of: (1) the resources R21 allocated to the UE 101A; (2) the resource R22 allocated to the UE 101B; and (3) the resource R23 allocated to the UE 101C. It should be noted that the BS 103 may allocate one additional resource on an interface, which is between the UE 101A and the BS 103, (e.g., (e.g., PUCCH or PUSCH resource on Uu interface) to the UE 101A for the UE 101A to report LBT outcome.

Then, the BS 103 instructs the UE 101A to perform type 1 LBT. When the UE 101A successful accesses a channel with type 1 LBT and initiates a COT C21 on the channel, the UE 101A transmits an LBT report 1014A to the BS 103.

Accordingly, the UE 101A may inform the UEs 101B and 101C of the resources R22 and R23 indicated by the BS 103. The UE 101B may perform a type 2 LBT based on the allocated resources R22, and the UE 101C may perform a type 2 LBT based on the allocated resources R23. In some implementations, as shown in FIG. 4B, the UEs 101B and 101C are allocated with different time slots i.e., the transmissions by the UEs 101B and 101C are time-division multiplexed. In some implementations, as shown in FIG. 4C, the UEs 101B and 101C are allocated with the same time slots and different frequencies, i.e., the transmissions by the UEs 101B and 101C are frequency-division multiplexed.

In some embodiments, the BS 103 may record associations of: (1) the resources R22 allocated to the UE 101B; and (2) the resource R23 allocated to the UE 101C in the resource allocation 1032. In detail, the information 1010 include identifications of the UE 101. After receiving the information 1010, the BS 103 respectively allocates the resources R21, R22 and R23 to the UEs 101A, 101B and 101C, and records the associations in the resource allocation 1032 as: (1) the resources R21 corresponding to the identification of the UE 101A; (2) the resources R22 corresponding to the identification of the UE 101B; and (3) the resources R23 corresponding to the identification of the UE 101C. In some cases, the identifications may be radio network temporary identifiers (RNTIs) of the UE 101. In some cases, the identifications may be source identifications of the UE 101.

In some embodiments, the BS 103 allocates the resources (e.g., resources R11 to R13 or resources R21 to R23) within the COT (e.g., COT C11 or COT C21) to the UEs 101 by regulation of that channel access priority class (CAPC) value for the type 1 LBT of the UE 101A should not be greater than CAPC value for type 1 LBT of the UE 101B and the UE 101C. For example, the information 1010 include priorities of the UEs 101, and the BS 103 satisfies the regulation by the priorities reported by the UE 101. The UE 101A has the highest priority among the priorities of the UE 101. The BS 103 indicates smallest CAPC value to the UE 101A.

In some embodiments, the BS 103 allocates the resources (e.g., resources R11 to R13 or resources R21 to R23) within the COT (e.g., COT C11 or COT C21) to the UEs 101 by regulation of that the UE 101A should be the reception UE of the transmissions transmitted from the UE 101B and the UE 101C on the allocated resources within the COT initiated by the UE 101A.

In some cases, when the UE 101B and the UE 101C broadcast data transmission(s) or groupcast the data transmission(s) without group establishment, the BS 103 presumes that the UE 101A is the reception UE of the data transmission(s) transmitted from the UE 101B and the UE 101C, and allocates the resources within the COT initiated by the UE 101A to the UEs 101A, 101B and 101C.

In some cases, the information 1010 includes a set of interested reception destination identifications reported by the UE 101A. When the UE 101B and the UE 101C broadcast data transmission(s) or groupcast the data transmission(s) without group establishment, the BS 103 allocates the resources within the COT initiated by the UE 101A to the UEs 101A, 101B and 101C if destination identification(s) of the data transmission(s) is (are) included (i.e., recorded) in the set of interested reception destination identifications reported by the UE 101A.

In some cases, the information 1010 includes a set of interested reception destination identifications reported by the UE 101A. When the UE 101B and the UE 101C groupcast data transmission(s) with group establishment and the group has a destination identification, the BS 103 allocates the resources within the COT initiated by the UE 101A to the UEs 101A, 101B and 101C if destination identification of the group is included (i.e., recorded) in the set of interested reception destination identifications reported by the UE 101A.

In some cases, the information 1010 includes a set of interested reception destination identifications reported by the UE 101A. When the UE 101B (or the UE 101C) unicasts data transmission(s) and the unicast connection has pair of source identification and destination identification, the BS 103 allocates the resources within the COT initiated by the UE 101A to the UE 101A and the UE 101B (or the UE 101C) if destination identification of the unicast connection is included (i.e., recorded) in the set of interested reception destination identifications reported by the UE 101A.

In some cases, the information 1010 includes zone identifications reported by the UEs 101A, 101B and 101C. The BS 103 allocates the resources within the COT initiated by the UE 101A to the UEs 101A, 101B and 101C if the zone identifications reported by the UEs 101A, 101B and 101C are the same.

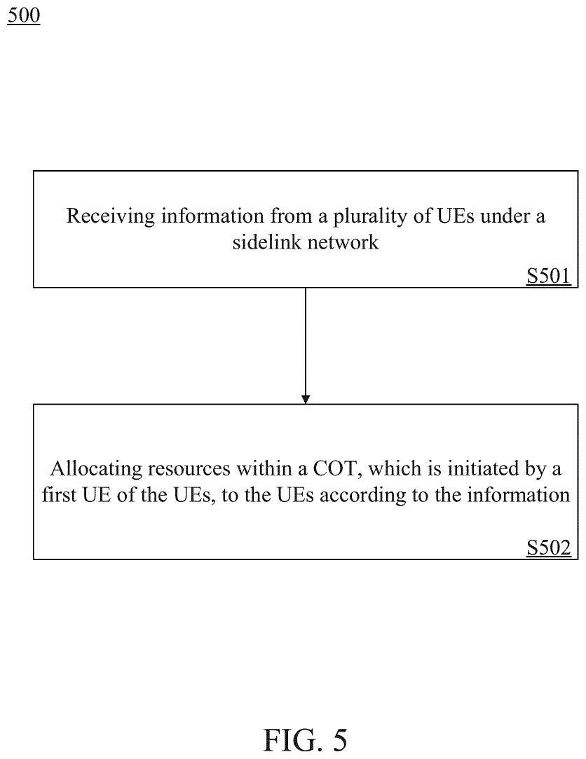

FIG. 5 illustrates a flow chart of a method for wireless communications in accordance with some embodiments of the present application. Referring to FIG. 5, method 500 is performed by a network device (e.g., the BS 103) in some embodiments of the present application.

In some embodiments, operation S501 is executed to receive, via the network device, information from a plurality of UEs under a sidelink network. Operation S502 is executed to allocate, via the network device, resources within a COT, which is initiated by a first UE of the UEs, to the UEs according to the information.

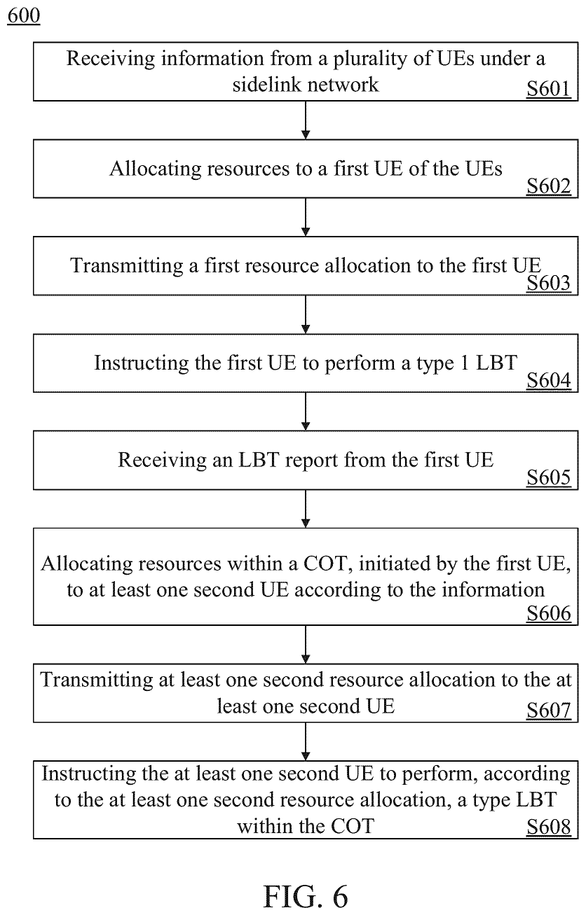

FIG. 6 illustrates a flow chart of a method for wireless communications in accordance with some embodiments of the present application. Referring to FIG. 6, method 600 is performed by a network device (e.g., the BS 103) in some embodiments of the present application.

In some embodiments, operation S601 is executed to receive, via the network device, information from a plurality of UEs under a sidelink network. Operation S602 is executed to allocate, via the network device, resources to a first UE of the UEs. Operation S603 is executed to transmit, via the network device, a first resource allocation to the first UE. Operation S604 is executed to instruct, via the network device, the first UE to perform, according to the first resource allocation, a type 1 LBT. Operation S605 is executed to receive, via the network device, an LBT report from the first UE.

Operation S606 is executed to allocate, via the network device, resources within a COT, initiated by the first UE, to at least one second UE according to the information. Operation S607 is executed to transmit, via the network device, at least one second resource allocation to the at least one second UE. Operation S608 is executed to instruct, via the network device, the at least one second UE to perform, according to the at least one second resource allocation, a type 2 LBT within the COT.

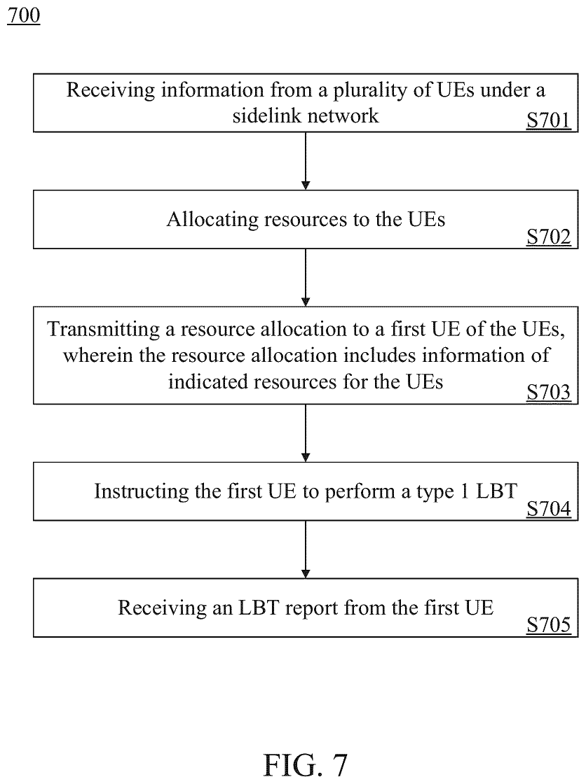

FIG. 7 illustrates a flow chart of a method for wireless communications in accordance with some embodiments of the present application. Referring to FIG. 7, method 700 is performed by a network device (e.g., the BS 103) in some embodiments of the present application.

In some embodiments, operation S701 is executed to receive, via the network device, information from a plurality of UEs under a sidelink network. Operation S702 is executed to allocate, via the network device, resources to the UEs. Operation S703 is executed to transmit, via the network device, a resource allocation to a first UE of the UEs. The resource allocation includes information of indicated resources for the UEs. Operation S704 is executed to instruct, via the network device, the first UE to perform a type 1 LBT. Operation S705 is executed to receive, via the network device, an LBT report from the first UE. In these embodiments, the first UE may perform COT sharing via sidelink to inform the other UE(s) the resources indicated by the BS according to the resource allocation transmitted from the BS.

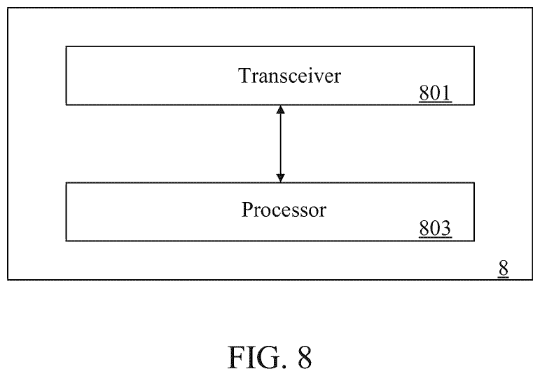

FIG. 8 illustrates an example block diagram of an apparatus 8 according to an embodiment of the present disclosure.

As shown in FIG. 8, the apparatus 8 may include at least one non-transitory computer-readable medium (not illustrated in FIG. 8), a transceiver 801 and a processor 803 electrically coupled to the non-transitory computer-readable medium (not illustrated in FIG. 8) and the transceiver 801. The apparatus 8 may be a UE or a BS.

Although in this figure, elements such as processor 803 and transceiver 801 are described in the singular, the plural is contemplated unless limitation to the singular is explicitly stated. In some embodiments of the present disclosure, the transceiver 801 may be separated into to circuitry, such as a receiving circuitry and a transmitting circuitry. In certain embodiments of the present disclosure, the apparatus 8 may further include an input device, a memory, and/or other components.

In some embodiments of the present disclosure, the non-transitory computer-readable medium may have stored thereon computer-executable instructions to cause a processor to implement the method with respect to the user equipment as described above. For example, the computer-executable instructions, when executed, cause the processor 803 interacting with the transceiver 801, so as to perform the operations with respect to the UE depicted in the figures.

Those having ordinary skill in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A network device for wireless communication, comprising:
at least one memory; and
at least one processor is coupled with the at least one memory and configured to cause the network device to:
receive information from a plurality of user equipment (UEs) under a sidelink network; and
allocate resources within a channel occupancy time (COT) to the UEs according to the information, wherein the COT is initiated by a first UE of the UEs.

2. The network device of claim 1, wherein the at least one processor is further configured to cause the network device to:
instruct the first UE to perform type 1 listen-before-talk (LBT);
receive a an LBT report from the first UE;
wherein allocating the resources within the COT to the UEs according to the information further comprises:
allocating the resources within the COT to at least one second UE according to the information; and
wherein the at least one processor is further configured to cause the network device to:
transmit at least one resource allocation to the at least one second UE; and
instruct the at least one second UE to perform, according to the at least one resource allocation, a type 2 LBT procedure within the COT.

3. The network device of claim 1, wherein allocating the resources within the COT to the UEs according to the information further comprises:
allocating the resources within the COT to the first UE and to at least one second UE according to the information;
wherein the at least one processor is further configured to cause the network device to:
transmit a resource allocation to the first UE;
instruct the first UE to perform type 1 listen-before-talk (LBT);
receive a an LBT report from the first UE.

4. The network device of claim 3, wherein the information include identifications of the UEs, and the resource allocation includes at least one identification of the at least one second UE and at least one resource designated to the at least one identification of the at least one second UE.

5. The network device of claim 4, wherein the identifications of the UEs includes radio network temporary identifiers (RNTIs) or source identifications.

6. The network device of claim 1, wherein at least one data transmission transmitted from the UEs other than the first UE is broadcasted or groupcasted without group establishment.

7. The network device of claim 6, wherein the information include a first set of interested reception destination identifications reported from the first UE, and the resources are allocated to the UEs when at least one second destination identification of the at least one data transmission is included in the first set of interested reception destination identifications.

8. The network device of claim 1, wherein at least one data transmission transmitted from the UEs other than the first UE is groupcasted with group establishment or unicasted, the information include a first set of reception destination identifications reported from the first UE, and the resources are allocated to the UEs when at least one second destination identification of the at least one data transmission is included in the first set of reception destination identifications.

9. The network device of claim 1, wherein the information includes zone identifications of the UEs, and the resources are allocated to the UEs when the zone identifications of the UEs are the same.

10. A first user equipment (UE) for wireless communication, comprising:
at least one memory; and
at least one processor coupled with the at least one memory and configured to cause the first UE to:
transmit information to a network device under a sidelink network for the network device to allocate resources within a channel occupancy time (COT) to a plurality of UEs according to the information, wherein the plurality of UEs include the first UE and the COT is initiated by the first UE; and
receive at least one resource allocation from the network device.

11. The first UE of claim 10, wherein the at least one resource allocation includes a first resource allocation of the first UE.

12. The first UE of claim 11, wherein the at least one resource allocation includes at least one second resource allocation of the UEs other than the first UE, and wherein the at least one processor is further configured to cause the first UE to:
inform the UEs other than the first UE of allocated resources within the COT according to the at least one second resource allocation; and
instruct the UEs other than the first UE to perform a type 2 listen-before-talk (LBT) procedure within the COT.

13. The first UE of claim 12, wherein the at least one second resource allocation includes at least one identification of the UEs other than the first UE and at least one resource designated to the at least one identification.

14. The first UE of claim 10, wherein the information includes at least one of:
an interested reception destination identification;
a reception destination identification; and
a zone identification.

15. A method performed by a network device, the method comprising:
receiving information from a plurality of user equipment (UEs) under a sidelink network; and
allocating, via the network device, resources within a channel occupancy time (COT) to the UEs according to the information, wherein the COT is initiated by a first UE of the UEs.

16. The method of claim 15, wherein the information includes zone identifications of the UEs, and the resources are allocated to the UEs when the zone identifications of the UEs are the same.

17. A processor for wireless communication, comprising:
at least one controller coupled with at least one memory and configured to cause the processor to:
transmit information to a network device under a sidelink network for the network device to allocate resources within a channel occupancy time (COT) to a plurality of UEs according to the information, wherein the plurality of UEs include the processor and the COT is initiated by the processor; and
receive at least one resource allocation from the network device.

18. The processor of claim 17, wherein the at least one resource allocation includes a first resource allocation of the processor.

19. The processor of claim 18, wherein the at least one resource allocation includes at least one second resource allocation of the UEs other than the processor, and wherein the at least one controller is further configured to cause the processor to:
inform the UEs other than the processor of allocated resources within the COT according to the at least one second resource allocation; and
instruct the UEs other than the processor to perform a type 2 listen-before-talk (LBT) procedure within the COT.

20. The processor of claim 19, wherein the at least one second resource allocation includes at least one identification of the UEs other than the processor and at least one resource designated to the at least one identification.
